(19) United States
(12) Patent Application Publication
(10) Pub. No.: US 2003/0093388 A1
(43) Pub. Date: May 15, 2003

(54) Automated product sourcing from multiple fulfillment centers

(76) Inventor: Brian Albright, Waconia, MN (US)

Correspondence Address: Beck & Tysver, P.L.L.C., Suite 100, 2900 Thomas Avenue S., Minneapolis, MN, 55416, US

(21) Appl. No.: 10/000,899

(22) Filed: Nov. 15, 2001

(51) Int. Cl. G06F 17/00

(52) U.S. Cl. 705/400

(57) ABSTRACT

A method and system are presented for analyzing delivery options available to a customer for a product that is available for shipment from multiple fulfillment centers. The present invention receives information from the customer relating to the customer address and the particular product desired. The inventories of the fulfillment centers are queried to see which centers have the product available. Estimated delivery dates are then calculated for each fulfillment center, taking into account the available to ship date, the shipping duration, and the possible delivery options available. The delivery dates and the total cost of the delivered product are compared to the other delivery dates and costs from the other fulfillment centers. A preferred subset of delivery options is then presented to the customer, including the estimated delivery dates.

### TECHNICAL FIELD

The present invention relates generally to product sourcing in a virtual or on-line retail environment. More particularly, the present invention relates to a system and method capable of analyzing multiple fulfillment center locations and shipping options in real time in order to present an optimal subset of options to a customer along with expected delivery dates.

### BACKGROUND OF THE INVENTION

In the last few years, the promise of business-to-consumer Internet retailing has become a reality. Retailers have established extensive web sets where customers can browse through and select from a large variety of products. In most of these virtual retail environments, the purchased products can be delivered directly to the consumer's home. Typically, this is accomplished by allowing the consumer to input a delivery address and request a particular delivery option, such as next day delivery or ground shipment. Retailers will then usually fulfill the order from inventory found at one or more fulfillment centers, and ship the purchased product to the delivery address. These fulfillment centers can be owned and operated by the retailer itself, or can be owned independently, operating for the benefit of the retailer under a contractual agreement.

It is possible for a retailer to have the desired product available for shipment from more than one fulfillment center. Duplicate inventory is maintained at multiple fulfillment centers in order to ensure better availability and more efficient delivery of products. The consumer is generally not made aware of these benefits, as the interface used by the consumer to select a delivery option in prior art systems does not reflect the existence of multiple fulfillment centers.

FIG. 1 shows an example web page 10 presenting customers with delivery options in the prior art. When an order is placed, the customer will generally have several delivery options to choose from, such as overnight delivery 12, two-day delivery 14, or ground shipment 16. These options are always made available to the customer regardless of which items are actually ordered, and regardless of product availability or the fulfillment center that will be used to fulfill the order. As shown in FIG. 1, each delivery option is presented along with a standard shipping and handling cost. This delivery cost might reflect the bulk and weight of the item being ordered, but it does not generally reflect any variability in cost as a result of the actual shipping distance. Finally, each shipping option 12-16 includes an estimate of how long it will take to deliver the item with each option, ranging from one business day for “Next day” delivery to three-ten business days for “Ground” delivery.

The web site 10 also includes an explanation 18 of how to calculate when the product might actually be delivered. This calculation usually involves two elements, namely order processing time and shipping time. The order processing time is the amount of time it will take to remove the item from inventory and place it in the hands of the delivery service. The shipping time indicates how long the delivery service will take before the product is delivered. Since both of these are only estimates, the actual delivery date can only be given by a range of possible dates. This is especially true in the case of ground shipments, which can take two to three days for deliveries in the same metropolitan area to over a week for a cross-continent delivery.

The prior art method 20 of presenting delivery options to a customer is set forth in FIG. 2. As can be seen in this method 20, no analysis of delivery time or costs is undertaken before the options are presented to the customer. Rather, the method begins with the customer indicating that they wish to purchase an item, such as by checking out a virtual shopping cart containing that item (step 22). The system then presents to the customer the list of standard delivery options in step 24. This list is usually presented in a separate web page during check out, such as page 10 of FIG. 1. When the customer selects a delivery option (step 26), the order is then submitted to the fulfillment center (step 28). The order is then shipped according to the selected delivery option as soon as possible in step 30, and the method ends at step 32.

Unfortunately, the prior art leaves the customer uncertain as to when the product will be delivered. This uncertainty can cause the customer to wonder and worry about a delivery that does not appear as early as hoped. If this concern causes the customer to call a customer support center, or to take business elsewhere, this concern will cost the retailer in both expenses and continued customer loyalty.

What is needed is a system that intelligently queries each of the available fulfillment centers for an ordered product, and presents the customer with an intelligently filtered option of delivery choices and delivery dates based on real-world experience.

### SUMMARY OF THE INVENTION

The present invention meets this need by providing a system and method that develops fulfillment plans based on the content of each order. Once an item is selected for purchase, the system is capable of determining which of the fulfillment centers will be able to present the item for delivery to the customer. The possible delivery options are then analyzed at each of the eligible fulfillment centers. This analysis includes a timing calculation to determine when the item will be available to ship, and how long the delivery options will take to deliver the product to the actual customer location. The analysis also analyzes the product cost, handling cost, and shipping cost for each delivery option at each fulfillment center.

These options are then pared down to a small set of preferred delivery alternatives. These alternatives will include those fulfillment center/delivery option pairs that minimize the time to delivery as well as the total price to the consumer. The system will then present the preferred delivery alternatives to the customer, with each alternative explaining the total cost to the customer and the expected delivery date. The customer is also presented with the option of selecting a delivery date. In this way, the customer can have a gift delivered on a particular day, or have a purchase delivered on a day when someone is available to receive the delivery. The shipping and handling charges are calculated according to the date selected by the customer.

Once the customer selects the delivery option, the system will forward the order to the fulfillment center or centers that can meet the desires of the customer. Items can be reserved for later shipment and taken out of available inventory in those situations where the customer has requested that the delivery be made on a certain date in the future.

### BRIEF DESCRIPTION OF THE DRAWINGS

FIG. 1 is a prior art web page showing delivery options presented to the customer.

FIG. 2 is a flow chart showing the prior art method of fulfillment sourcing.

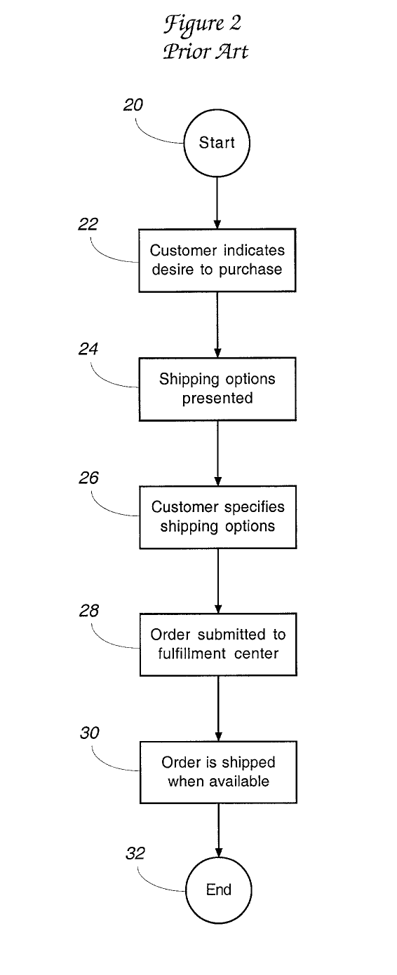

FIG. 3 is a block diagram showing the elements of the present invention system.

FIG. 4 is a three dimension map containing block elements representing a customer and three fulfillment centers.

FIG. 5 is a table showing the analysis of delivery options for a product available from three different fulfillment centers.

FIG. 6 is a web page showing delivery options presented to the customer under the present invention.

FIG. 7 is a table showing the shipping details and total calculated total price for a variety of available delivery dates.

FIG. 8 is a second web page of the present invention, showing the delivery options after pruning to eliminate inefficient delivery options and the results of choosing a custom delivery date.

FIG. 9 is a third web page of the present invention, showing an additional delivery option added to the web page of FIG. 8.

FIG. 10 is a flow chart of the general method of the present invention.

FIG. 11 is a flow chart of the procedure for determining delivery options in the present invention.

FIG. 12 is a table showing delivery options available for shipping two items in a single order.

FIG. 13 is a table similar to that shown in FIG. 5, with each fulfillment center having a different product cost that is reflected in a possible discounted price.

### DETAILED DESCRIPTION OF THE INVENTION

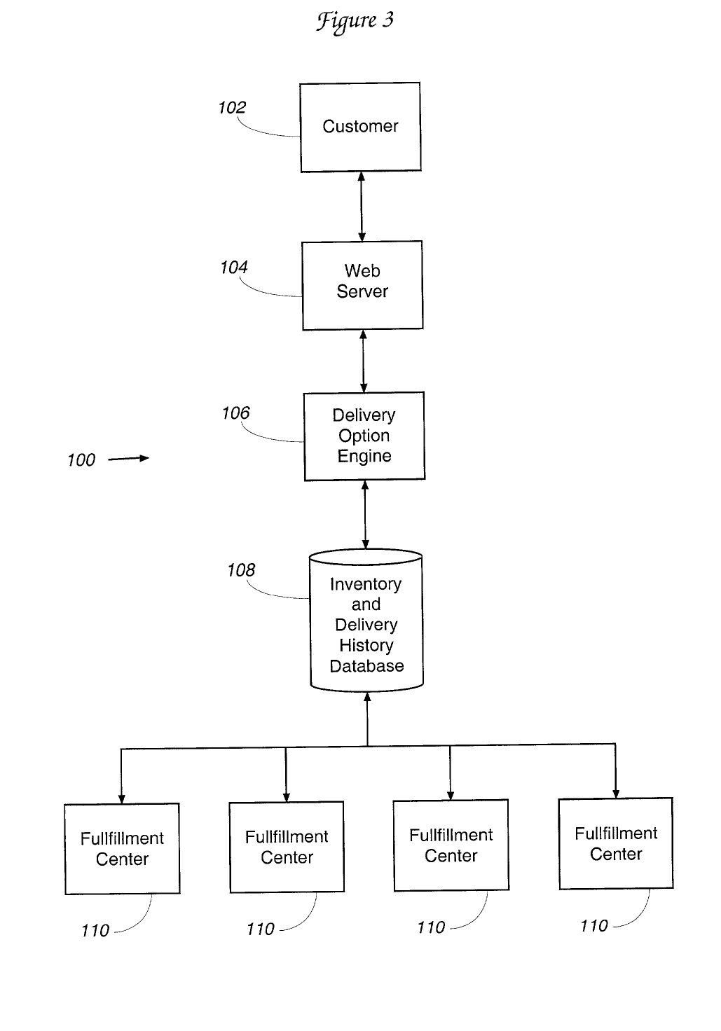

The system 100 used by the present invention is shown in FIG. 3. In this system 100, a customer 102 interacts with a web server 104 that manages a virtual retail environment, such as an e-commerce web site. The web server 104 handles all product presentations, order taking, and all other interactions with the customer 102. When a customer 102 has indicated to the web server 104 that they are ready to purchase a particular item or items, the web server 104 requests delivery timing and cost information from the delivery option engine 106.

This engine 106 is responsible for determining the preferred delivery options for the web server 104 to present to the customer 102. In order to make this determination, the engine 106 receives from the web server 104 an indication of the desired product or products and the delivery address for the customer 102. Using this information, the delivery option engine 106 queries the inventory and delivery history database 108 to obtain inventory information for the product. This database 108 maintains or is otherwise aware of the current inventory for a plurality of fulfillment centers 110, and hence will be able to inform the engine 106 about which centers 110 have the product available. The database 108 is also able to calculate delivery dates for each of the centers 110 having inventory available, utilizing a variety of shipping options. The calculated delivery dates and related shipping costs are then compared by the delivery option engine 106 to develop the preferred delivery options for the web server 104.

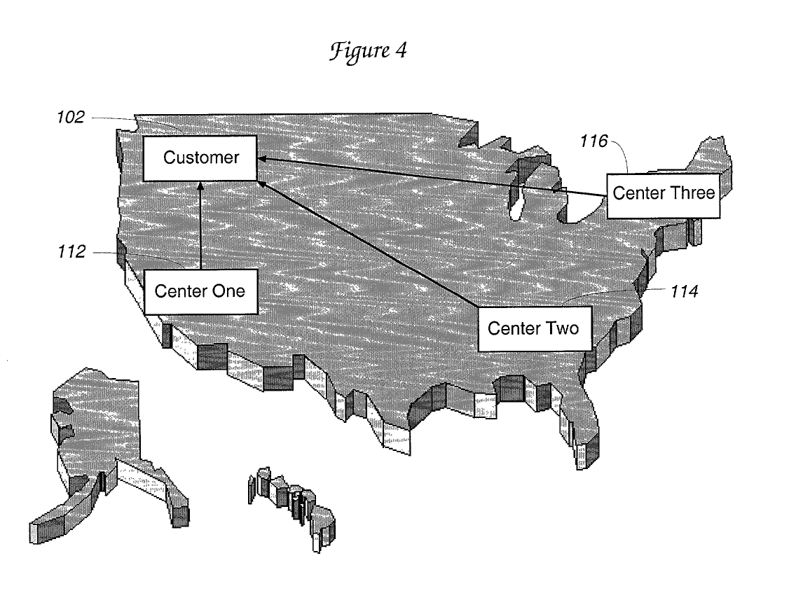

FIG. 4 shows a sample situation in which a customer 102 located in the Northwest United States has expressed a desire to purchase a product. The delivery option engine 106 has determined that the product is available in three different fulfillment centers 110, namely center one 112 in the Southwest United States, center two 114 in the Southeast United States, and center three 116 in the Northeast United States. Each of these centers 112-116 is capable of shipping the product to customer 102 via one of three different delivery services, namely next day delivery, two-day delivery, and ground shipment delivery.

In this situation, the delivery option engine 106 will query the inventory and delivery history database 108 to determine the shipping and handling cost of delivering the product from each of the fulfillment centers 112, 114, and 116 to the customer 102. In addition, the engine 106 will request ready-to-ship dates for each center 112, 114, and 116, as well as delivery duration times for each type of delivery from each center 112, 114, and 116.

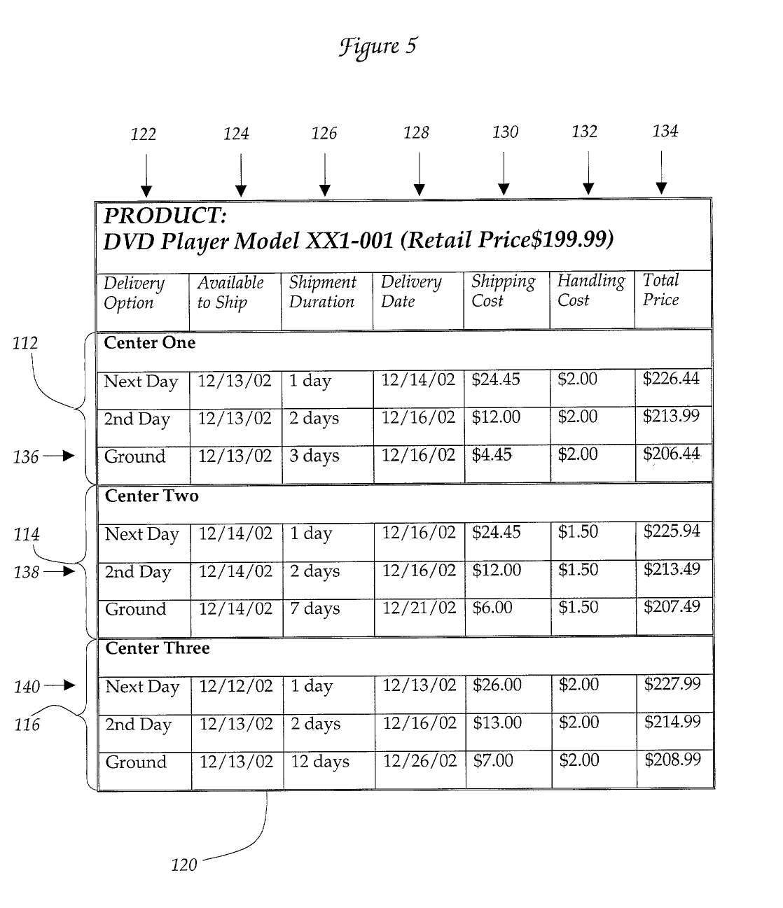

The information obtained by the delivery option engine 106 can be represented in chart form, such as chart 120 shown in FIG. 5. Chart 120 shows the shipping options available to ship a particular product, namely a DVD player, based on a Dec. 12, 2002 purchase request. Each center 112-116 is associated with three rows of data, one row for each type of delivery available. Seven columns of information are presented in chart 120. The first row 122 simply shows the type of delivery service being described in the row. The second row 124 contains the “available to ship” date, which indicates the date on which it will be possible to ship the product from that center 112-116 using that type of delivery service. If an order is placed early in the business day, it is possible that the available to ship day will be the same day as the order is placed. In some cases, the fulfillment center 112-116 may require twenty-four to forty-eight hours after the order is placed before the product can be ready to ship. It is also possible that a particular center 112-116 will have different available to ship dates depending on the type of shipment available. For instance, center three 116 has an available to ship date of Dec. 12, 2002 for next day delivery, but an available to ship date of Dec. 13, 2002 for the other two types of shipment. This might indicate that the next day delivery service used by center three 116 has a later pick up time at the fulfillment center 116 than the delivery service used for the other two methods of shipment. The available to ship date 124 may also reflect an out of stock situation, in which case the date that the product is available to ship would reflect the expected date upon which the fulfillment center 112-116 would have received the product and be able to ship.

The third column of information 126 is the expected shipment duration. This time frame is determined based on historical shipments from the particular fulfillment center 112-116 to the location of the customer 102. By using actual history to determine the duration of the shipment, realistic delivery dates can be calculated. The historical data of shipment duration can be kept by the retailer using their own experience, or can be provided by the shipper actually handling the delivery using the shipper's broader experience.

The delivery date in column 128 is calculated using the available to ship date 124 along with the shipment delivery time 126. In addition, the delivery date takes into account days in which deliveries are not made, such as Sundays and holidays. For example, second day delivery from center one 112 and center three 116 both take three days, because the second day falls on Dec. 15, 2002, which is a Sunday. Similarly, ground delivery from center three 116 would normally arrive on Dec. 25, 2002, which is a holiday.

The shipping cost is found in column 130. The shipping cost 130 can vary from fulfillment center 110 to center 110, since each center 110 might negotiate a different deal with the delivery service. In addition, the shipping cost 130 can reflect the physical distance covered in the shipment. Thus, ground delivery from center three 116 is more expensive than ground delivery from center one 112, which reflects the greater distance from center three 116 to customer 102 than from center one 112 to customer 102.

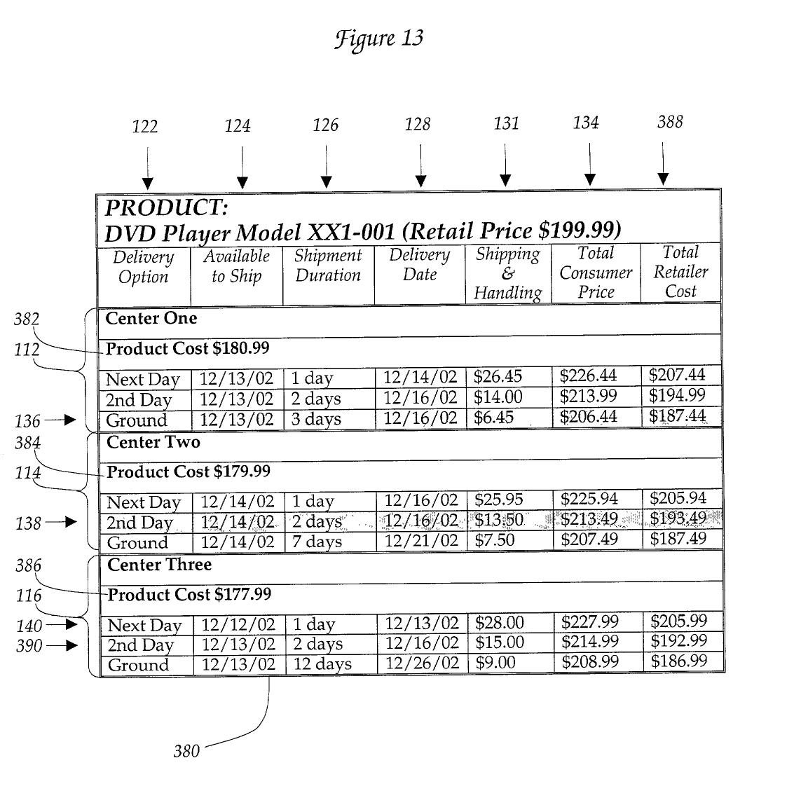

The handling cost found in column 132 might vary from center 110 to center 110. In chart 120, center one 112 and center three 116 charge a $2.00 handling fee per product, while center two 114 charges only $1.50. The shipping cost 130 and handling costs 132 are combined with the retail price to determine the total price to the customer, as shown in column 134. In chart 120, the DVD player selected by the customer 102 has a retail price of $199.99, which is not dependent upon which fulfillment center 112-116 is selected for shipment. Of course, it would be within the scope of the present invention to vary the retail price of the product according to which center 112-116 ships the product, and to then reflect this price difference in the total price shown in column 134. It is also possible that the cost of the product for the retailer will vary depending upon the center 112-116 that is used for shipment. This situation, and an embodiment that utilizes this information to select a fulfillment center 112-116, is discussed below in connection with FIG. 13.

The delivery option engine 106 is responsible for analyzing the information found on chart 120 in order to present to the customer 102 the optimum fulfillment center 112-116 and delivery service option 122 combinations. One simple way to analyze this information is to determine which of the fulfillment centers 112-116 provides the best service and price combination for each of the different delivery service options 122. Starting first with ground delivery, center one 112 can deliver the product faster and cheaper than any of the other two fulfillment centers 114, 116, as shown by row 136. With second day delivery, each of the fulfillment centers can delivery the product on Dec. 16, 2002. Since center two 114 can deliver the product for a lower total price to the consumer, as shown by row 138, center two 114 is the preferred option for second day delivery.

Next day delivery is slightly more complicated. A comparison of the next day delivery options for the three centers 112-116 indicates that center two 114 is the least expensive, with center one 112 coming in second. Center three 116 is the most expensive. On the other hand, thanks to an earlier available to ship date 124, center three 116 is able to deliver the product faster than the other two centers 112, 114. To select between these centers 112-116 for next day delivery, the delivery option engine 106 will have to weigh the difference in total price versus the earlier delivery date to determine which is the preferred fulfillment center 112-116 for next day delivery. It is likely that the delivery option engine 106 will be programmed to prefer an earlier delivery date given the relatively small difference in total price between the three centers 112-116, and will prefer the combination shown for center three 116 in row 140.

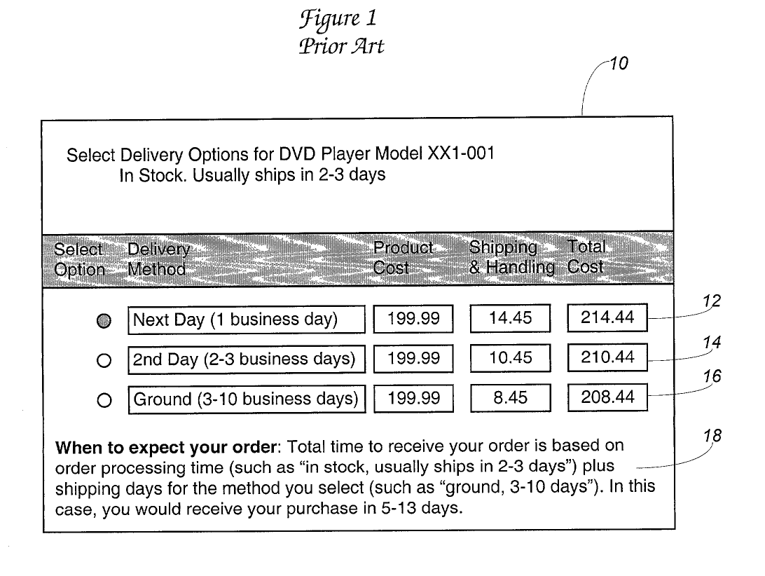

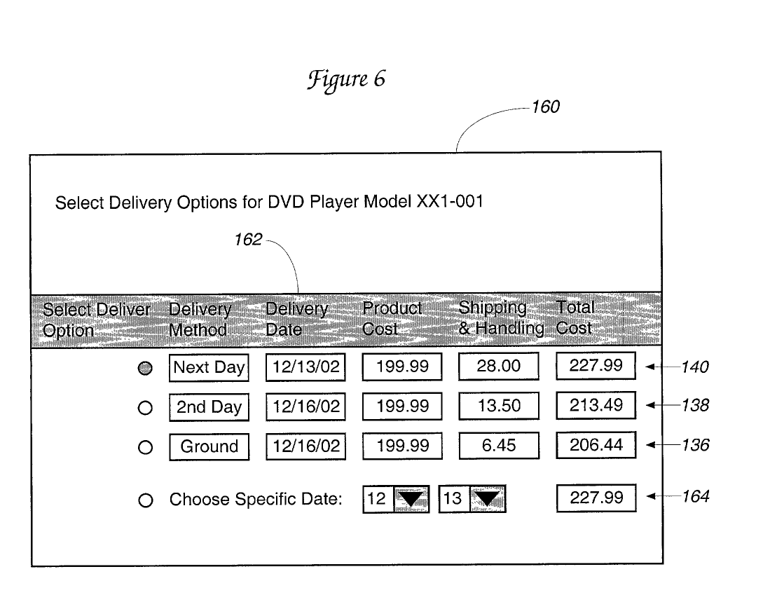

These preferred options 136, 138, and 140 would then be presented to the customer 102 via web server 104. A sample web page 160 showing these options 136, 138, and 140 is shown in FIG. 6. This web page 160 differs from prior art page 10 of FIG. 1 in that the web page 160 of FIG. 6 includes an actual estimated delivery date 162 for each of the delivery options 136-140. In the web page 10 of FIG. 1, the customer 102 must combine the estimate of when a product is available to ship and the estimate of shipment duration to develop a rough idea of when the product might arrive. Because the delivery information on page 10 is not based on actual delivery and availability data from the best fulfillment center 110, this information is inherently less accurate and precise than the estimated delivery dates 162 provided by web page 160.

Web page 160 also includes a specify delivery date option 164, in which a customer 102 can specify the actual date on which they wish to take delivery. This option 164 not only allows the customer 102 to choose their preferred delivery date, but it also automatically calculates the total cost for the shipment. Each of the possible dates within a certain time frame has been pre-analyzed by the delivery option engine 106 and is associated with the most price effective fulfillment center 112-116 and delivery option 122 that can be used to have delivery occur on the desired date.

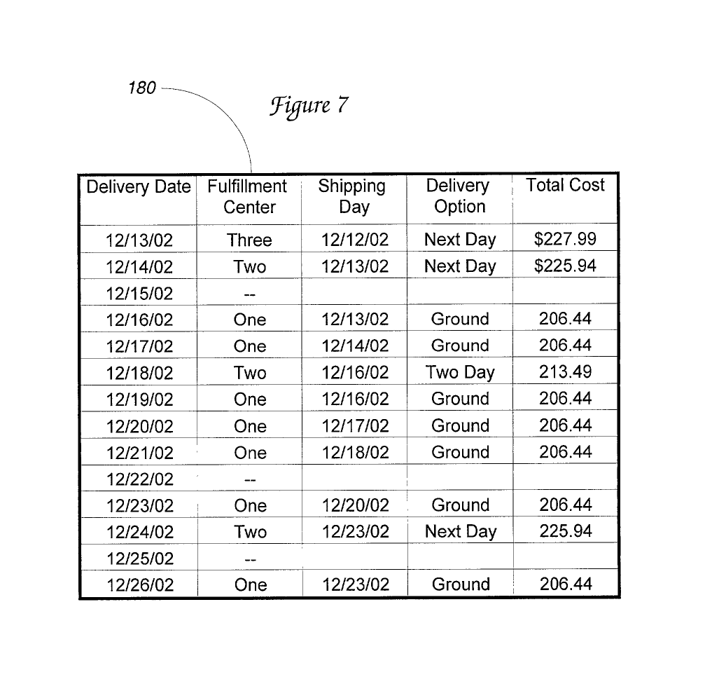

A table 180 of such associations is shown in FIG. 7. For each delivery date, the least expensive combination of fulfillment center 112-116 and delivery options 122 are selected. This table 180 embodies certain information about dates of operation as well. For instance, none of the delivery methods allow Sunday delivery, so there is no delivery option that can make deliveries on Dec. 15, 2002 or Dec. 22, 2002. Similarly, no delivery can be made on Dec. 25, 2002. Table 180 also realizes that none of the fulfillment centers ship products on Sundays. Hence, it is not possible to ship a package via ground delivery from fulfillment center one 112, and have it reach the customer on Dec. 18, 2002. Since neither of the other fulfillment centers 114, 116 can ship via ground by this date, the only delivery option available is a two-day delivery shipped on Dec. 16, 2002. As a result, the total cost for delivery on that date is higher than the cost for the preceding or succeeding day. In addition, the table 180 realizes that only next day delivery will deliver on Dec. 24, 2002. Hence, delivery on that day is also more expensive.

The earliest date shown in table 180 is Dec. 13, 2002, one day after the Dec. 12, 2002 request to purchase the product. However, some retailers are capable of receiving in-store pick-up orders through their virtual shopping web site. These stores could add an additional line to table 180 reflecting a Dec. 12, 2002 availability date. If this option is added to table 180, the web page 160 presenting this option to the customer 102 should make it clear that the product must be picked up at the physical store. It would be well within the scope of the present invention for the delivery option engine 106 to present this option to the customer 102, and even to present the customer 102 with the address of the physical store located closest to the customer 102. In store delivery would entail no shipping costs, with the handling costs varying according to the policies of the particular retailer. It is also possible that retailers that allow same-day in-store pick-up would also arrange for a local delivery service to pick up the package at the store and delivery to the customer 12, thus allowing same-day delivery.

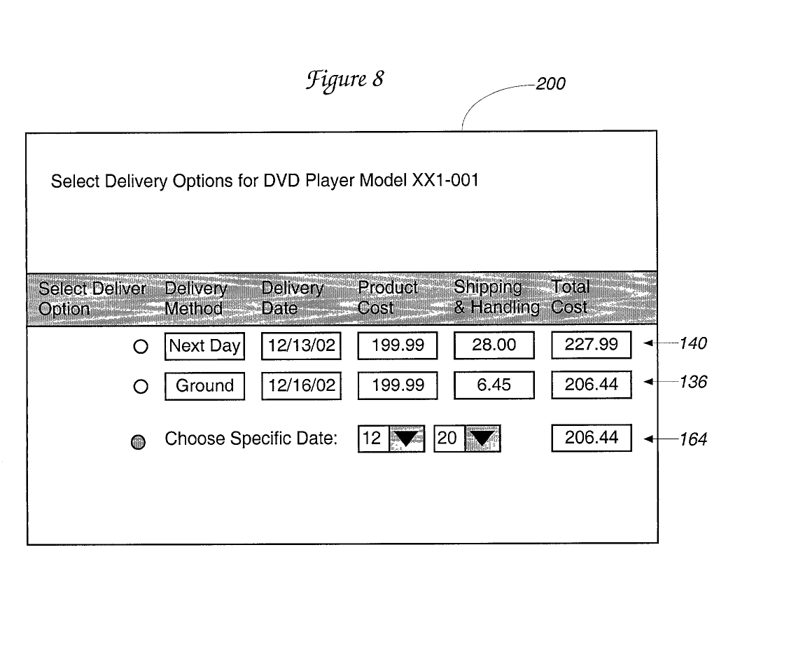

When determining options to present to the customer 102, the delivery option engine 106 can use any number of business rules to select the “best” options for presentation. For instance, of the options 136-140 presented on web page 160, option 138 is superfluous, since it offers the same delivery date as option 136 at a higher price. It would have been a simple matter for delivery option engine 106 to remove or “prune out” such superfluous options, and present just option 136 and 140 to the customer, such as shown in web page 200 found on FIG. 8. Web page 200 also shows the situation where a customer has chosen a specific delivery date in the specify delivery date option 164, with the correct total price automatically being calculated according to table 180.

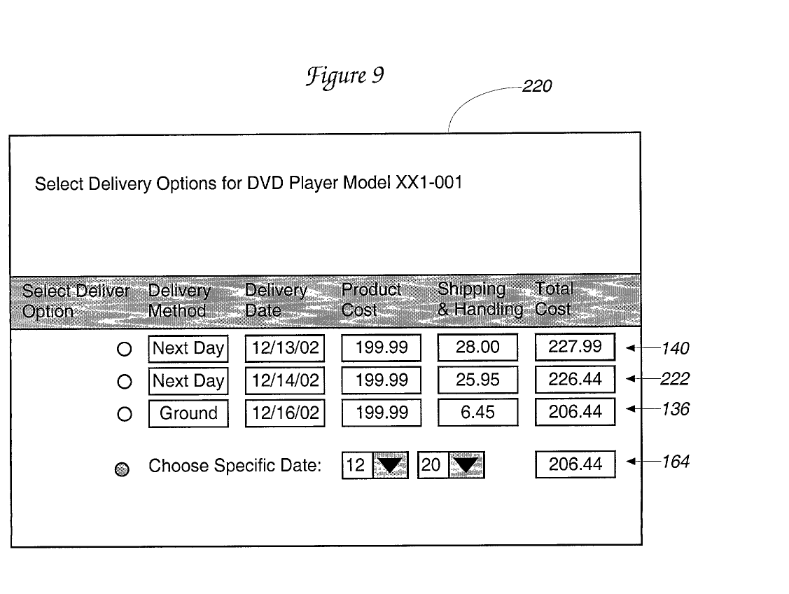

Another option for the business rules governing the operation of delivery option engine 106 is to present the customer with every option that is not superfluous. That is, every option is presented to the customer as long as that option is not both slower and more expensive than another option. Referring again to FIG. 5, there are three options that meet this criteria. These options, shown on web page 220 found on FIG. 9, include options 136 and 140 from the earlier web pages 160, 200. In addition, option 222 is presented, which represents next day delivery from fulfillment center one 112. While this delivery option 222 arrives one day later than option 140, the customer 102 does save one dollar and fifty-five cents. If the customer 102 simply needs the item before the fifteenth, they might be willing to get the shipment a day later and save the money.

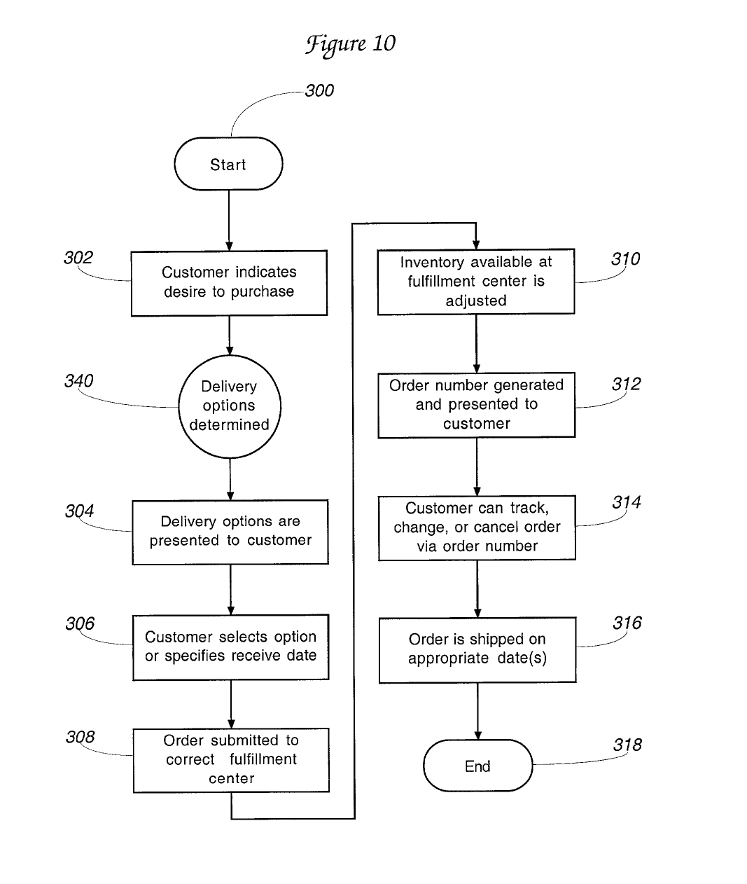

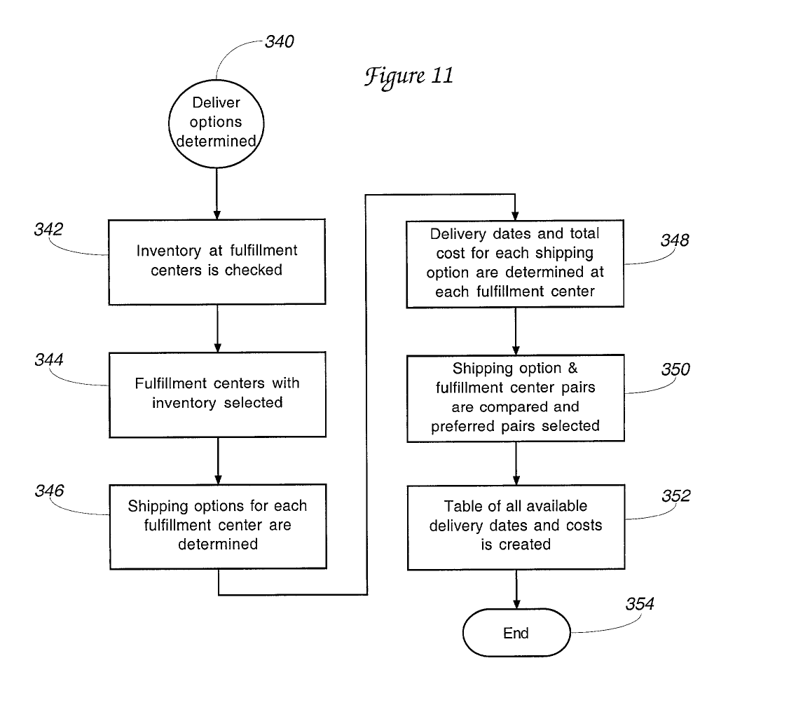

The method 300 for using the present invention is shown in FIGS. 10 and 11. FIG. 10 shows that the method 300 starts with the customer indicating a desire to purchase a particular product (step 302). Once the system 100 receives this information, it is provided to the delivery option engine 106 along with the delivery address for the customer so that the delivery options can be determined. The detailed description of how the delivery options are determined are set forth in procedure 340, which is shown in FIG. 11 and described in more detail below.

After procedure 340 determines the delivery options, the web server 104 presents those options to the customer 102 at step 304. The customer 102 then either selects one of the presented options, or else specifies a particular receive date (step 306). Once the web server 104 receives the selection of the customer 102, the server 104 submits the order to one of the fulfillment centers 110 at step 308. This is easy to accomplish because the delivery option engine 106 associates the delivery options that it presents to the web server 104 with a particular fulfillment center 110. Thus, when a customer 102 selects a delivery option in step 306, the web server 104 will know which fulfillment center should be notified of the order in step 308. This is true whether the customer 102 selects one of the presented options, or whether the customer 102 selects their own delivery date.

The appropriate fulfillment center 110 then adjusts its inventory to indicate that the product selected by the customer is no longer available for commitment (step 310). This is done immediately, even if the product will not ship for a while to meet the customers selected receive date. If inventory were not immediately decreased upon acceptance of an order from the customer 102, there would be a risk that the product would no longer be in stock on the appropriate shipment date.

An order number is then generated and presented to the customer 102 through the web server 104 at step 312. Ideally, this order number will allow the customer to track their order through the shipment process, so that at any point the customer will know the status of their order. It would even be possible to allow the customer to change or cancel the order using this number if the change or cancellation occurs before the shipment date (step 314). Finally, the order is shipped on the appropriate date at step 316, and the method 300 ends at step 318.

FIG. 11 shows the detail relating to the procedure 340 for determining the appropriate delivery options. The first step 342 is to check inventory for the ordered product at each of the available fulfillment centers 110. Those centers 110 with available (or soon to be available) inventory are selected at step 344, and a list of available shipping options at the selected centers 110 is created at step 346. For each shipping option, delivery dates and total consumer price are then determined at step 348. The delivery date determination is made according to the available to ship date and the duration anticipated for shipping the product from the center 110 to the customer 102, which is based on the duration of past, similar shipments.

In step 350, the pairs of delivery dates and prices are then compared and one or more preferred pairs are selected according to business rules generated by the retailer. In addition, the delivery option engine 106 can also create a table 180 of all available delivery dates and their associated delivery costs. This is shown as step 352 in FIG. 11. The deliver options determined procedure 340 then ends at step 354.

In the method 300 described above, the determination of fulfillment options is not undertaken until the customer indicates a desire to purchase. For example, the determination might not be made until the customer “checks out” a shopping cart containing the product. However, the determination could also be made at an earlier time in the shopping cycle, such as when a product is placed in a shopping cart, or even when the product is being browsed by the customer 102. By pre-determining availability, delivery dates, and total prices, the customer would not have to wait for such calculations to be done at the time of purchase. In addition, the web server 104 could present such information to the customer before a purchase decision is made to help influence that decision. All that would be necessary is the ability to know a customer's delivery address before the purchase transaction is made, which can be accomplished through the use of customer sign-in screens or the use of Internet cookies.

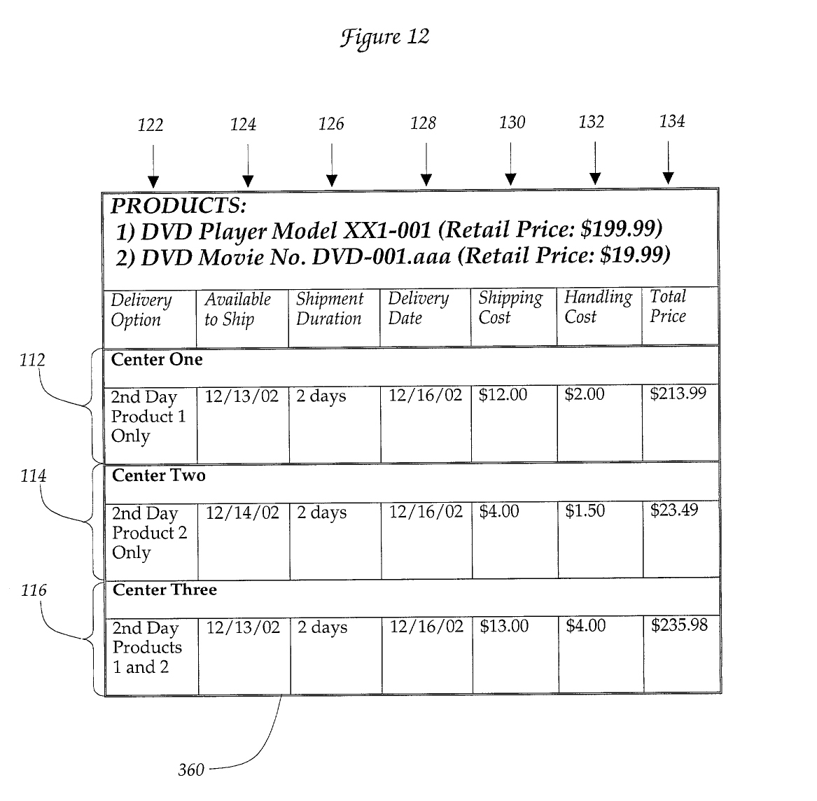

The above method 300 also describes the present invention in the context of a single product being purchased. The present invention, however, is equally applicable to transactions where several products are purchased at a single time. For instance, FIG. 12 shows a chart 360 that is similar to chart 120 of FIG. 5, except that this chart is for two products and compares only second day delivery. In the example of chart 360, fulfillment center one 112 has only the first product available for shipment, while fulfillment center two 114 has only the second product available. Both centers can ship the products so that they arrive by Dec. 16, 2002 at a total price of $237.48. In contrast, fulfillment center three 116 has both items available for delivery. Since the items can be shipped together, the shipping costs are lower, even though the handling charge must be charged for each item. As a result, center three 116 can deliver both items by Dec. 16, 2002 for only $235.98, and hence will be preferred over the separate shipments from center one 112 and center two 114.

Special business rules can be developed to handle multiple item orders. For instance, business rules could prefer splitting an order if the result is that part of the order can arrive at an earlier date. Alternatively, the business rules might look only at the order completion date (i.e., the date on which all of the items in an order have been delivered). In this case, splitting an order may not be advantageous since the earlier arrival of a separate, first shipment is not considered advantageous, while a single shipment of multiple products will save on shipping costs. Of course, these business rules are merely examples. Other business rules might prioritize things differently, but would still be within the scope of the present invention.

In the above description, all shipment and handling cost savings were passed on to the customer 102 in the form of a lower, overall retail price. There is no requirement that this take place. It would be well within the scope of the present invention to charge a customer 102 a set shipping and handling price, and to use the present invention simply to lower the retailer's expenses.

In addition, the above descriptions assume the retailer would pay an identical product cost regardless of which fulfillment center 112-116 is used to ship the product. This is not always the case. FIG. 13 shows a table 380 that reflects the fact that the wholesale cost paid by the retailer might vary depending on the fulfillment center 112-116 that ships the product. In table 380, row 382 reveals that center one 112 charges the retailer $180.99 for the DVD player ordered by the customer. Similarly, row 384 shows that center two 114 charges $179.99, and row 386 shows a wholesale price of $177.99 at center three 116. Table 380 is otherwise similar to table 120 of FIG. 5, except that the shipping costs 130 and handling costs 132 have been combined into a single column 133, and that a total retailer cost column 390 has been added. The total retailer cost 390 is simply the total of the wholesale product cost 382-386 and the shipping and handling costs 133.

The total retailer cost 388 can be utilized in a variety of ways. For instance, this cost 388 could be ignored except in circumstances where the delivery option engine 106 is comparing two pairs of delivery dates 128 and consumer prices 134 that are identical to each other. In these circumstances, the total retailer cost 388 could be used to break the tie, with the engine 106 choosing the center 112-116 with the lower cost 388.

Alternatively, the delivery option engine 106 can use the total retailer cost 388 in place of the total consumer price 134 in its basic comparison. Given the data in table 380, rows 136 and 140 would still represent the optimum delivery date 128 and retailer cost 388 combinations for ground and next day delivery, just as they were when the total consumer price 134 was being used in the analysis. In fact, next day delivery from fulfillment center three 116 (row 140) is even more advantageous, since the total cost for the retailer 388 is now lower than the total cost 388 for next day delivery from center one 112.

The analysis of second day delivery, however, changes when retailer cost 388 is used in the analysis rather than the total consumer price 134. Second day delivery from center two (row 138) had the lowest total consumer price 134. However, second day delivery from center three 116 (row 390) has the lowest total retailer cost 388. As a result, the delivery option engine 106 might now select row 390 as the best option for second day delivery.

When total retailer cost 388 is used to analyze delivery options instead of total consumer price 134, it is possible that an option with a higher consumer price 134 (such as row 390) will be chosen over another option having the same delivery date and a lower consumer price 134 (such as row 138). In this case, the delivery option engine 106 may choose to discount the price 134 charged to the customer 102 so as to match the best consumer price available. In the example of FIG. 13, the delivery option engine 106 would present row 390 to the web server 104 as the best second day delivery option available. However, the engine 106 would discount the shipping and handling charges 131 associated with row 390 one dollar and fifty cents. Thus, the consumer would see a shipping and handling charge of $13.50, and a total consumer price of $213.49, just as was shown in FIG. 6. The retailer would still have to pay the full $15.00 shipping and handling charge to fulfillment center three 116, even though only $13.50 was collected from the customer 102. This loss is more than offset, however, by the two dollars that the retailer saved in product costs. Of course, if the discount of the shipping and handling charges 131 exceeds the savings in product costs, the delivery option engine could simply select the shipping option with the lower consumer price 134.

Many other combinations of features and elements are also within the scope of the present invention. For instance, the present invention was described primarily in the context of an e-commerce web site that allowed customers 102 to purchase products via a web server 104. However, the invention would be equally applicable in any retail situation where direct deliveries to a customer's address are made from a warehouse or fulfillment center, such as a web clipping service, the i-mode technology of NTT DoCoMo, or some other protocol now developed or developed in the future. Alternatively, the present invention was described as discounting the shipping and handling costs when a shipping option selected by the delivery option engine had a higher consumer price than another available option. It would be well within the scope of the present invention to simply present the consumer with the higher shipping and handling costs. In addition, the inventory and delivery history database is shown in FIG. 3 as a single database. It would be clear to one of ordinary skill that the present invention could access more than one database to obtain the information that is described as coming from the inventory and delivery history dataabase. Because many such combinations are present, the scope of the present invention is not to be limited to the above description, but rather is to be limited only by the following claims.

What is claimed is:

1. A method for analyzing delivery options for a desired product to an address of a customer comprising:
a) selecting a plurality of fulfillment centers that have the product available;
b) calculating at least one estimated delivery date for the product for each of the plurality of fulfillment centers;
c) calculating a total delivery cost for each estimated delivery date;
d) combining the estimated delivery dates and related total delivery costs into delivery options; and
e) pruning out some of the delivery options according to business rules, leaving a set of remaining delivery options.

2. The method of claim 1, further comprising:
f) presenting the remaining delivery options and the estimated delivery dates to the customer for selection.

3. The method of claim 2, wherein the delivery options are presented along with the total delivery cost for each of the delivery options.

4. The method of claim 2, wherein the delivery options are presented by showing the customer the estimated delivery date and a standard delivery cost that is independent of the calculated delivery cost.

5. The method of claim 2, wherein the delivery date is calculated by examining an available to ship date and a shipping duration time that reflects historical shipping experience from the fulfillment center to proximate the customer address.

6. The method of claim 5, wherein multiple estimated delivery dates are calculated for at least some of the fulfillment centers, the multiple estimated delivery dates representing the estimated delivery date for the fulfillment center using a plurality of different delivery service options.

7. The method of claim 6, wherein the plurality of delivery service options are chosen from a set including same day pick up, same day delivery, next day delivery, two day delivery, and ground shipment.

8. The method of claim 6, wherein the business rules select particular delivery options from particular fulfillment centers based upon an earliest estimated delivery date for each delivery service option.

9. The method of claim 6, wherein the step of pruning removes superfluous delivery options that have an estimated delivery date on the same or later date than a delivery option having a lesser delivery cost.

10. The method of claim 5, wherein the business rules select particular delivery options from particular fulfillment centers based upon an earliest estimated delivery date.

11. The method of claim 5, wherein the step of pruning removes superfluous delivery options that have an estimated delivery date on the same or later date than a delivery option having a lesser delivery cost.

12. The method of claim 5, further comprising the calculation for each delivery option of a total retailer cost that combines the total delivery cost with a cost of the product to the retailer at the fulfillment center.

13. The method of claim 12, wherein the step of pruning removes superfluous delivery options that have an estimated delivery date on the same or later date than an delivery option have a lesser total retailer cost.

14. The method of claim 13, further comprising:
g) allowing the customer to choose a selected delivery option having a selected delivery date.

15. The method of claim 14, wherein the customer is charged a delivery fee for the selected delivery option equal to the least expensive total delivery cost in the set of total delivery costs for delivery options that have an estimated delivery date equal to the selected delivery date.

16. The method of claim 1, further comprising:
f) creating a table of all available delivery dates and selecting one preferred delivery option for each delivery date according to business rules.

17. The method of claim 16, further comprising:
g) presenting the table of delivery dates to the customer;
h) allowing the customer to select one of the delivery dates; and
i) presenting the customer with the total delivery cost for the selected delivery date.

18. The method of claim 17, wherein the preferred delivery option associated with the selected delivery dates determines which fulfillment center is utilized to delivery the desired product.

19. A method for analyzing delivery options for a desired product to an address of a customer comprising:
a) selecting a plurality of fulfillment centers that have the product available;
b) calculating at least one estimated delivery date for the product for each of the plurality of fulfillment centers;
c) calculating a total delivery cost for each estimated delivery date;
d) combining the estimated delivery dates and related total delivery costs into delivery options;
e) creating a table of all available delivery dates and selecting one preferred delivery option for each delivery date according to business rules;
f) presenting the table of delivery dates to the customer;
g) allowing the customer to select one of the delivery dates; and
h) presenting the customer with the total delivery cost for the selected delivery date.

20. The method of claim 19, wherein the business rules for selecting the preferred delivery option operate in part by removing superfluous delivery options that have an estimated delivery date on the same or later date than a delivery option having a lesser total delivery cost.

21. A system that allows a retailer to present delivery options to a customer for a desired product comprising:
a) a plurality of fulfillment centers;
b) at least one database containing information relating to
i) inventories of the fulfillment centers,
ii) historical delivery duration for the fulfillment centers,
iii) delivery and shipment holiday schedules, and
iv) available to ship dates;
c) a virtual store server for providing a user interface to the customer to allow the customer to select the desired product and to input a customer address; and
d) a delivery option engine having
i) a database interface to query the database for delivery options, each delivery option indicating a particular fulfillment center that has the desired product available, an estimated delivery date, and a delivery cost;
ii) a delivery option analysis engine to prune out some delivery options, leaving a set of remaining delivery options;
iii) a server interface to receive information from the virtual store server, and to present the remaining delivery options to the virtual store server.

22. The system of claim 21, wherein the estimated delivery date is calculated using the available to ship date for the desired product at the particular fulfillment center and the delivery duration data for the particular fulfillment center shipping to an area proximate to the customer address.

23. The system of claim 21, wherein the delivery option analysis engine prunes out delivery options via business rules that remove superfluous delivery options that have an estimated delivery date on the same or later date than a delivery option having a lesser delivery cost.

24. The system of claim 21, wherein each delivery option also indicates a cost of the product at the particular fulfillment center which is combined with the delivery cost to calculate a total cost for the retailer.

25. The system of claim 24, wherein the delivery option analysis engine prunes out delivery options via business rules that remove superfluous delivery options that have an estimated delivery date on the same or later date than a delivery option having a lesser total cost for the retailer.
